(19) United States
(12) Patent Application Publication
(10) Pub. No.: US 2009/0002716 A1
(43) Pub. Date: Jan. 1, 2009

(54) LASER SCANNING INTERFEROMETRIC SURFACE METROLOGY

(76) Inventors: David Nolte, Lafayette, IN (US); Manoj Varma, West Lafayette, IN (US); Fred E. Regnier, West Lafayette, IN (US)

Correspondence Address: BOSE MCKINNEY & EVANS LLP, 111 MONUMENT CIRCLE, SUITE 2700, INDIANAPOLIS, IN, 46204, US

(21) Appl. No.: 12/181,043

(22) Filed: Jul. 28, 2008

Related U.S. Application Data
(63) Continuation of application No. 11/345,564, filed on Feb. 1, 2006, now Pat. No. 7,405,831.
(60) Provisional application No. 60/649,071, filed on Feb. 1, 2005.
(60) Provisional application No. 60/648,724, filed on Feb. 1, 2005.

(51) Int. Cl. G01B 9/02

(52) U.S. Cl. 356/511

(57) ABSTRACT

An apparatus for assessing topology of a surface of a target. The apparatus includes an optical source for generating a probe laser beam. The apparatus also includes means for scanning the probe laser beam across at least a portion of the surface of the target. The apparatus further includes a beamsplitter for redirecting a return signal toward means for detecting the return signal in a substantially quadrature condition, the return signal resulting from reflection of the probe laser beam off the surface of the target. A quadrature interferometric method for determining the presence or absence of a target analyte in a sample. The method comprises generating a laser probe beam having a wavelength λ and a waist wₒ to probe at least a portion of a substrate having a reflecting surface that has been exposed to the sample. The reflecting surface includes at least a first region having a layer of recognition molecules specific to the target analyte and a second region that does not include a layer of recognition molecules specific to the target analyte. The method also comprises scanning the first region and the second region while the substrate is maintained in a substantially fixed position. The method further comprises measuring a time dependent intensity of a reflected diffraction signal of the probe beam while scanning the probe beam across the first region and the second region.

### RELATED APPLICATIONS

This application is a continuation of U.S. patent application Ser. No. 11/345,564, filed Feb. 1, 2006, which claims priority to U.S. Provisional Patent Application No. 60/649,071, filed Feb. 1, 2005, entitled “Laser Scanning Inteferometric Assays,” the applications of which are hereby incorporated by reference in their entirety.

This application also claims priority to four additional U.S. provisional applications: (1) U.S. Provisional Application No. 60/649,043, filed Feb. 1, 2005, entitled “Multiplexed Laser-Scanning Interferometric Biochips and Biodisks” [and also U.S. application Ser. No. 11/345,477 being filed on the same day as the present application that claims priority to this provisional application and entitled “Multiplexed Biological Analyzer Planar Array Apparatus and Methods”]; (2) U.S. Provisional Application No. 60/648,724 filed Feb. 1, 2005, entitled “Method for Conducting Carrier-Wave Side-Band Optical Assays for Molecular Recognition” [and also U.S. utility application Ser. No. 11/345,566 being filed on the same day as the present application that claims priority to this provisional application and entitled “Differentially Encoded Biological Analyzer Planar Array Apparatus and Methods”]; and (3) U.S. Provisional Patent Application No. 60/649,070, filed Feb. 1, 2005, entitled “Phase-Contrast Quadrature For Spinning Disk Interferometry And Immunological Assay”; and (4) U.S. Provisional Patent Application No. 60/755,177, filed Dec. 30, 2005, entitled “Phase-Contrast BioCD: High-Speed Immunoassays at Sub-Picogram Detection Levels” [U.S. provisional applications (3) and (4) resulting in U.S. utility application Ser. No. 11/345,462 being filed on the same day as the present application and entitled “Method and Apparatus for Phase Contrast Quadrature Interferometric Detection of an Immunoassay”]. All of the aforementioned utility patent applications are incorporated herein by reference.

This application is also related to pending U.S. application Ser. No. 10/726,772 filed Dec. 3, 2003 [published as US 2004/0166593 on Aug. 26, 2004] as well as its parent application that resulted in U.S. Pat. No. 6,685,885.

### FIELD OF THE INVENTION

The present invention generally relates to a device for detecting surface height changes, and more particularly to a laser scanning system for detecting the presence of surface height differences caused by surface topology and/or structure or biological pathogens and/or analyte molecules bound to target receptors by sensing changes in the optical characteristics of a probe beam reflected from the surface caused by height discontinuities or by the pathogens and/or analytes.

### BACKGROUND OF THE INVENTION

In the field of material processing, it is desirable to be able from a stand-off distance to detect surface heights or densities using a laser probe. In the more specific case of chemical, biological, medical, and diagnostic applications, it is desirable to detect the presence of specific molecular structures in a sample. Many molecular structures such as cells, viruses, bacteria, toxins, peptides, DNA fragments, and antibodies are recognized by particular receptors. Biochemical technologies including gene chips, immunological chips, and DNA arrays for detecting gene expression patterns in cancer cells, exploit the interaction between these molecular structures and the receptors. [For examples see the descriptions in the following articles: Sanders, G. H. W. and A. Manz, Chip-based microsystems for genomic and proteomic analysis. Trends in Anal. Chem., 2000, Vol. 19(6), p. 364-378. Wang, J., From DNA biosensors to gene chips. Nucl. Acids Res., 2000, Vol. 28(16), p. 3011-3016; Hagman, M., Doing immunology on a chip. Science, 2000, Vol. 290, p. 82-83; Marx, J., DNA Arrays reveal cancer in its many forms. Science, 2000, Vol. 289, p. 1670-1672]. These technologies generally employ a stationary chip prepared to include the desired receptors (those which interact with the target analyte or molecular structure under test). Since the receptor areas can be quite small, chips may be produced which test for a plurality of analytes. Ideally, many thousand binding receptors are provided to provide a complete assay. When the receptors are exposed to a biological sample, only a few may bind a specific protein or pathogen. Ideally, these receptor sites are identified in as short a time as possible.

As a separate example, both biological chips and electronic chips (including, but not limited to, semiconductor wafers) contain complex surface structures that are fabricated as part of the function of the chip. These surface features are becoming steadily smaller, scaling now into the nanometer range. Conventional laser profilometers are not able to detect such small changes. Interferometric techniques have been successful in this range, but require stringent vibration isolation and mechanical stability to operate.

There is a need for improved interferometric and/or techniques that may be used to measure these surface structures.

### SUMMARY OF THE INVENTION

In one embodiment of the present invention there is an improved stable nanometer-scale and sub-nanometer-scale interferometric techniques that may be used to measure surface structures.

One embodiment according to the present invention includes a laser deflector unit that translates a laser probe laterally at the surface of the test object. Light reflected from the object retraces the ray path and is preferably reflected by a beam splitter into a quadrature detection system. The quadrature detection system can be comprised of several classes, including micro-diffraction [see U.S. Pat. No. 6,685,885], adaptive optic [see U.S. application Ser. No. 10/726,772 filed Dec. 3, 2003 and published as Pub. No. US 2004/0166593], and phase contrast [U.S. utility application Ser. No. 11/345,462 being filed on the same day as the present application and entitled “Method and Apparatus for Phase Contrast Quadrature Interferometric Detection of an Immunoassay”]. The quadrature detection is a transducer that converts phase modulation, imprinted on the beam by the surface topology, into direct intensity modulation that is detected by a detector, hence providing a means of detecting surface height and/or density.

In another embodiment of the present invention there is an apparatus for assessing topology of a surface of a target. The apparatus includes an optical source for generating a probe laser beam. The apparatus also includes means for scanning the probe laser beam across at least a portion of the surface of the target. The apparatus further includes a beamsplitter for redirecting a return signal toward means for detecting the return signal in a substantially quadrature condition, the return signal resulting from reflection of the probe laser beam off the surface of the target.

In one refinement of an embodiment of the invention the means for scanning includes a parallel plate.

In another refinement of an embodiment of the invention the means for scanning further includes a galvanometer for rotating the parallel plate at high speed.

In another refinement of an embodiment of the invention the means for scanning includes a deflector mirror.

In another refinement of an embodiment of the invention the means for scanning further includes a galvanometer for rotating the deflector mirror at high speed.

In another refinement of an embodiment of the invention the means for scanning is a lens that is laterally deflected.

In another refinement of an embodiment of the invention the means for scanning includes an acousto-optic modulator.

In another refinement of an embodiment of the invention the apparatus further includes a lens with a focal length f for focusing the probe laser beam with a waist wₒ on the surface of the target, the lens being positioned between the means for scanning and the target.

In another refinement of an embodiment of the invention the means for detecting return signal in a substantially quadrature condition includes an adaptive optic element used in conjunction with two separate photodetectors.

In another refinement of an embodiment of the invention the adaptive optic element is a photorefractive quantum well.

In another refinement of an embodiment of the invention the means for detecting return signal in a substantially quadrature condition includes a split photodetector.

In another refinement of an embodiment of the invention the probe laser beam has a wavelength λ, and wherein the split photodetector is a detector array positioned at a pair of quadrature angles Θ_{q}, the quadrature angles being defined from a ray normal to the target by a formula: θ_{q}=sin⁻¹(λ/2wₒ).

In another refinement of an embodiment of the invention the apparatus further includes an inverting circuit and a summing circuit.

In another refinement of an embodiment of the invention the acousto-optic modulator is offset from the lens by a distance f, and wherein the lens is offset from the surface of the target by a distance f.

In another embodiment of the invention there is a quadrature interferometric method for determining the presence or absence of a target analyte in a sample. The method comprises generating a laser probe beam having a wavelength λ and a waist wₒ to probe at least a portion of a substrate having a reflecting surface that has been exposed to the sample. The reflecting surface includes at least a first region having a layer of recognition molecules specific to the target analyte and a second region that does not include a layer of recognition molecules specific to the target analyte. The method also comprises scanning the first region and the second region while the substrate is maintained in a substantially fixed position. The method further comprises measuring a time dependent intensity of a reflected diffraction signal of the probe beam while scanning the probe beam across the first region and the second region.

In one refinement of an embodiment of the invention the scanning is done using an acousto-optic modulator in conjunction with a lens.

In another refinement of an embodiment of the invention the reflected diffraction signal of the laser beam is measured using a split-photodetector configuration. The method further comprising inverting a first output portion of the reflected signal corresponding to the one of the pair of quadrature angles, and summing the inverted first output with a second output of the reflected signal corresponding to the other of the pair of quadrature angles.

In another refinement of an embodiment of the invention the reflecting surface is substantially flat and the quadrature angles are defined from a ray normal to the substrate by a formula: Θ_{q}=sin⁻¹(λ/2wₒ).

In another refinement of an embodiment of the invention the reflecting surface of the substrate includes a plurality of lands and a plurality of ridges, the ridges having a height h, and the quadrature angles are defined from a ray normal to the substrate by a formula: Θ_{q}=sin⁻¹[(λ/2−4 h)/wₒ].

In another refinement of an embodiment of the invention the scanning is done by sweeping an angular deflection by sweeping a sound frequency in the acousto-optic modulator. The method further comprising dithering the probe laser beam, wherein the dithering is accomplished by superposing a high speed frequency on top of the slower scan frequency sweep.

In another refinement of an embodiment of the invention the method further comprises dithering the probe laser beam.

In another embodiment of the present invention there is a method for a high rate of inspection of a surface of a target using laser scanning quadrature interferometric detection. The method comprises generating a probe laser beam having a wavelength λ. The method also comprises passing the probe beam through an acousto-optic modulator for angular deflection of the probe beam and then passing the deflected beam through a lens having a focal length f to focus the probe beam to a waist wₒ on the surface of the target. The method further comprises measuring a time dependent intensity in a substantially quadrature condition of a reflected diffraction signal resulting from scanning the probe beam across at least a portion of the surface of the target, the scanning occurring via controlling the angular deflection caused by the acousto-optic modulator.

In one refinement of an embodiment of the invention the method further comprises dithering the probe laser beam.

In another refinement of an embodiment of the invention the quadrature condition is maintained by measuring the time dependent intensity using a split photodetector.

In another refinement of an embodiment of the invention the quadrature condition is maintained using an adaptive optic element.

Another embodiment according to the present invention includes a deflector unit composed of a lens that is translated laterally, thus deflecting the focused beam laterally on the target.

Another embodiment according to the present invention includes a deflector unit composed of an optical plate in the path of the beam that is tilted and thereby deflects the beam across the surface of the target.

Another embodiment according to the present invention includes an acoustic-optic modulator with a controllable frequency and telescopic lens to convert angular deflection by the modulator into linear deflection at the target surface.

Various embodiments disclosed herein are intended for use in scanning the small scale features of a surface of a stationary target including, but not limited to, biological substrates (such as chips or bioCDs) and electronic substrates (such as chips or semiconductor wafers). It should be understood that it is contemplated as within the scope of the invention that the target may be within a vacuum chamber and may be subject to interferometric detection (preferably quadrature interferometric detection) through, for example, a substantially transparent window into the chamber.

In one exemplary embodiment of the present invention, a programmed laser scanner scans over periodic or a-periodic patterns of immobilized biomolecules on a flat or curved surface.

Although the present invention has been described with reference to certain exemplary embodiments, it is understood that variations and modifications exist and are within the scope of the present invention.

### BRIEF DESCRIPTION OF THE FIGURES

FIG. 1 illustrates one embodiment of a self-referencing laser scanning quadrature system.

FIG. 2 illustrates an embodiment of a plane parallel plate self-referencing laser scanner.

FIG. 3 illustrates an embodiment of a deflector mirror self-referencing laser scanner.

FIG. 4 illustrates an embodiment of an acousto-optic self-referencing laser scanner shown in phase-contrast quadrature.

FIG. 5 illustrates an example of an application of a laser scanning quadrature system in which the target is inside a vacuum system.

FIG. 6 illustrates an embodiment of a simple lens deflection system without compensation.

FIG. 7 illustrates time trace of amplitude channel and both phase channels.

FIG. 8 illustrates the amplitude channel after demodulating beam walk-off showing a monolayer of printed antibody protein on a silicon wafer.

FIG. 9 illustrates the phase channel showing protein edge in the edge-detection mode of phase-contrast quadrature.

FIGS. 10(a)-(c) illustrates various embodiments of laser scanning track trajectories in two dimensions. FIG. 10(a) shows a linear set of tracks. FIG. 11(b) shows the tracks can take on any 2D parametric transformation of generalized curvilinear coordinates ξ(x,y), ξ(x,y). FIG. 10(c) shows the track trajectories can be general closed or open trajectories.

### DETAILED DESCRIPTION

The biological compact disc was introduced as a sensitive spinning-disk interferometer that operates at high-speed and is self-referencing [see M. M. Varma, H. D. Inerowicz, F. E. Regnier, and D. D. Nolte, “High-speed label-free detection by spinning-disk micro-interferometry,” Biosensors & Bioelectronics, vol. 19, pp. 1371-1376, 2004]. Self-referencing is preferable in performing stable interferometry on a mechanically spinning disk. In order to be sensitive to optical path length, the relative phase between the signal and reference beams is locked to substantially quadrature (π/2 phase difference), preferably independent of mechanical vibrations or motion. Two quadrature interferometric detection classes of BioCD were previously defined. The micro-diffraction class (“MD-class”) [see M. M. Varma, D. D. Nolte, H. D. Inerowicz, and F. E. Regnier, “Spinning-disk self-referencing interferometry of antigen-antibody recognition,” Optics Letters, vol. 29, pp. 950-952, 2004. Also see U.S. Pat. No. 6,685,885 to Nolte et al] and the adaptive optic class (“AO-class”) [see U.S. patent application Ser. No. 10/726,772 filed Dec. 3, 2003 entitled “Adaptive Interferometric Multi-Analyte High-Speed Biosensor”, which is incorporated by reference herein in its entirety].

The MD-class BioCD locks to quadrature using microstructures fabricated on the disk that diffract a focused laser beam to the far field with a fixed relative phase. In one embodiment, gold spokes, preferably 1024 to a disk, that have a height of λ/8 are deposited by evaporation onto a reflecting surface, and bio-molecules are immobilized on either the gold spokes or the land. Because the phase difference is set by the height difference of the local microstructure, it is unaffected by mechanical motion or vibration. Immobilized bio-molecules change the relative phase which is converted to amplitude modulation in the far field.

The AO-class locks to quadrature using self-adaptive nonlinear optical mixing, preferably in a photorefractive quantum well [see D. D. Nolte, “Semi-insulating semiconductor heterostructures: Optoelectronic properties and applications,” J. Appl. Phys., vol. 85, pp. 6259, 1999; D. D. Nolte and M. R. Melloch, “Photorefractive Quantum Wells and Thin Films,” in Photorefractive Effects and Materials, D. D. Nolte, Ed. Dordrecht: Kluwer Academic Publishers, 1995] that adaptively tracks the phase between the signal and the reference [see D. D. Nolte, T. Cubel, L. J. Pyrak-Nolte, and M. R. Melloch, “Adaptive Beam Combining and Interferometry using Photorefractive Quantum Wells,” J. Opt. Soc. Am. B, vol. 18, pp. 195-205, 2001]. In one embodiment, patterned protein structures modulate optical phase of the probe beam, which is sent to a photorefractive quantum well (PRQW) device and mixed with a reference local oscillator beam by two-wave mixing. The two-wave mixing self-compensates mechanical disturbances to maintain the quadrature condition with a compensation rate higher than a kHz. Phase modulation caused by protein structures on the spinning disk have frequencies higher than the compensation rate and is read out by photodetector. As previously noted, for further details of the AO-class see U.S. patent application Ser. No. 10/726,772 filed Dec. 3, 2003 entitled “Adaptive Interferometric Multi-Analyte High-Speed Biosensor”, previously incorporated by reference herein in its entirety.

These BioCD quadrature classes traded off complexity between the near-field and the far-field. MD-class BioCDs appear to require more complex microstructuring on the disk, while AO-class disks required holographic films for the nonlinear optical mixing. Thus, a third quadrature class analogous to phase-contrast imaging was developed that is referred to as the Phase-Contrast class (“PC-class”). The PC-class of quadrature interferometric detection is discussed in the previously mentioned U.S. Provisional Patent Application No. 60/649,070, filed Feb. 1, 2005, entitled “Phase-Contrast Quadrature For Spinning Disk Interferometry And Immunological Assay”; and U.S. Provisional Patent Application No. 60/755,177, filed Dec. 30, 2005, entitled “Phase-Contrast BioCD: High-Speed Immunoassays at Sub-Picogram Detection Levels”. The PC-class of quadrature interferometric detection is further disclosed in U.S. utility application Ser. No. 11/345,462 being filed on the same day as the present application and entitled “Method and Apparatus for Phase Contrast Quadrature Interferometric Detection of an Immunoassay”, previously incorporated herein by reference.

Prior to describing various embodiments of the present invention the intended meaning of quadrature in the quadrature interferometric detection systems of the present invention is further explained. In some specific applications quadrature might be narrowly construed as what occurs in an interferometric system when a common optical “mode” is split into at least 2 “scattered” modes that differ in phase about N*π/2 (N being an odd integer). However, as used in the present application an interferometric system is in quadrature when at least one mode “interacts” with a target region and at least one of the other modes does not, where these modes differ in phase by about N*π/2 (N being an odd integer). This definition of quadrature is also applicable to interferometric systems in which the “other mode(s)” interact with a different portion of the target. The interferometric system may be considered to be substantially in the quadrature condition if the phase difference is π/2 (or N*π/2, wherein N is an odd integer) plus or minus approximately twenty percent.

Additionally, prior to describing various embodiments of the present invention that make use of the previously mentioned (and previously incorporated herein by reference) PC-class disclosure relating to quadrature interferometric detection, the intended meaning of “edge” or “edge-detection” in the present application is set forth. Various portions of the description of one or more embodiments below might refer to an edge that diffracts light. It will be understood by those of ordinary skill in the art that the description for all embodiments disclosed herein of a step or an edge diffracting light in reality refers to the fact that light diffraction is integrated over the full optical wavefront. Strictly speaking it is not just the edge that diffracts light. It is the discontinuity or step that is integrated over the beam that diffracts to the far field and is detected. The discontinuity of the step of the differing heights places different conditions on the wave to the left and right. It is the integrated difference that is detected as diffraction, and not just a step or an edge. Moreover, with respect to the present application the term “edge” or “edge-detection” is intended to encompass generally the differential detection techniques disclosed herein. That is to say, quadrature interferometric detection that detects the slope or derivative of the surface height. The signal is proportional to dh(x)/dx. While more common usage of the term might indicate that only in the special case of a discontinuous step is something an “edge-detection” process, the terms as used herein are intended to be defined more broadly as set forth in this paragraph to also encompass “slope detection” across a step.

Interferometric detection in quadrature was generally considered to be incompatible with laser scanning. Most scanning systems operate on the principle of scattered light off diffuse targets, or absorption of light by opaque regions on targets. Among the difficulties with interferometry using laser scanning is the changing beam orientation and changing path lengths. These changing quantities make it difficult to lock the relative phase of a signal and a reference to π/2. The sensitivity advantage of interferometry, however, makes a compelling case to develop a stable means of locking to quadrature in a laser scanning system.

An important aspect of quadrature scanning is a stable phase relationship between a signal and a reference wave established through self-referencing. As discussed above, various patent applications describe the establishment of self-referencing interferometry through microdiffraction, adaptive optics and phase contrast on, for example, a spinning disk. In the spinning disk embodiments, a relevant feature is the capability of high speed optical sampling that shifts the measurement far from 1/f noise. The laser spot in these applications was preferably stationary. In the preferred embodiments of the present application, however, the target remains fixed while the laser is in motion. This simple difference (target fixed while laser in motion versus target in motion while laser fixed) creates non-trivial differences in the implementation of the optical system.

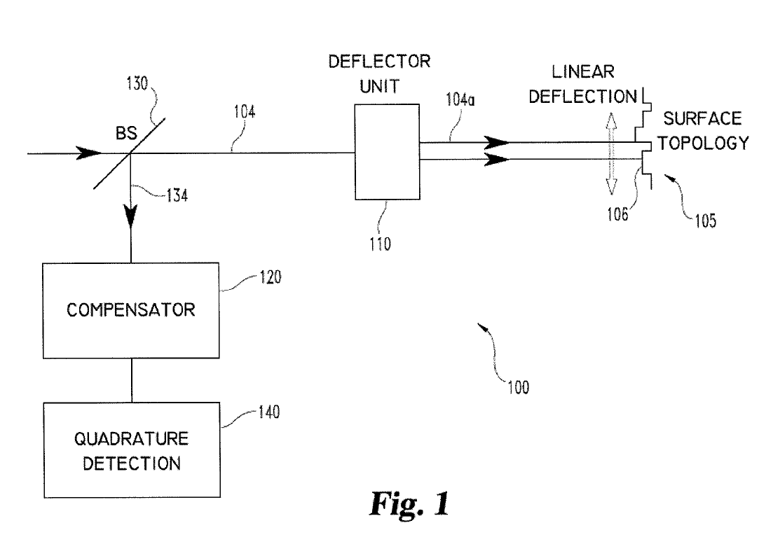

In one embodiment of the present invention, laser scanning with self-referencing quadrature preferably includes a displacement element to shift the beam laterally, a compensation element to compensate for the beam shift to keep optical path differences to much smaller than a wavelength, and quadrature detection that converts phase modulation into intensity modulation. This general system is shown in FIG. 1.

Operation of the system preferably includes high-speed dithering of the lateral beam displacement. Dithering means small excursions of the beam at high speed. The purpose of the dithering is to bring the frequency of the optical detection to high frequency far from 1/f noise. Those of ordinary skill in the art will understand that gross lateral displacements of the beam relative to the target could be accomplished either by shifting the target itself, or by the use of a larger but slower deflection superposed on top of the high-speed small dither. The small displacements in the high speed dither are preferably larger than the size of the laser focal spot. Focal spots can be quite small, down to microns, meaning that the dither displacement likewise may be only a few microns.

Referring to FIG. 1 there is shown a general self-referencing laser scanning quadrature system 100. System 100 comprises a deflector unit 110 that shifts and/or scans the incident probe beam 104 across the surface 106 of a target 105. System 100 further comprises a beam splitter 130 that redirects return signal beam 134 (resulting from beam 104a incident on surface 106 of target 105) toward a compensator 120 to keep optical path length changes to less that a wavelength. System 100 further includes quadrature detection 140 that converts phase modulation into intensity modulation.

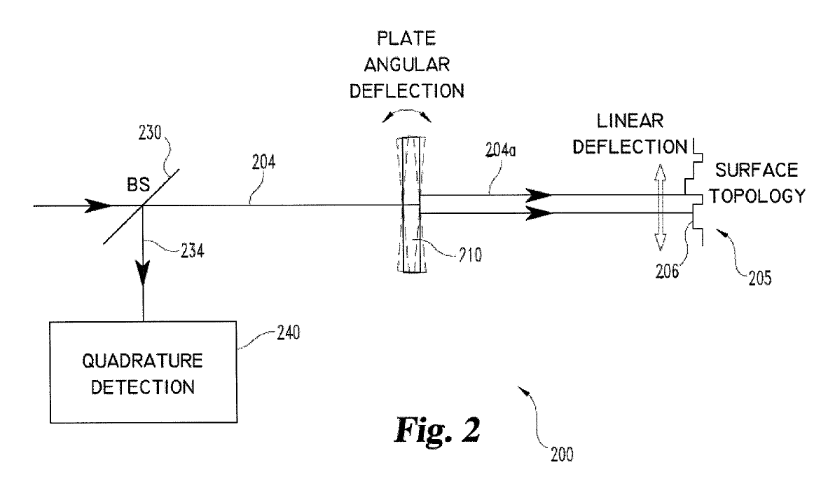

With reference to FIG. 2 there is shown a plane parallel plate scanner 200. Incident probe beam 204 passes through plate 210. The plate 210 is preferably rotated at high speed to dither the laser spot of the incident probe beam 204a on the surface 206 of target 205. The return beams 234 retrace their paths exactly, providing for automatic compensation. System 200 further comprises a beam splitter 230 that redirects return signal beam 234 (resulting from beam 204a incident on surface 206 of target 205). System 200 further includes quadrature detection 240 that converts phase modulation from the target 205 into intensity modulation in the quadrature detection 240.

It should be understood that a wide variety of embodiments of means for scanning the laser beam across the surface of the target are contemplated as within the scope of the invention. That is to say, the deflector unit 110 can take a wide variety of forms that are disclosed herein. For example, as just discussed above and shown in FIG. 2, a plane-parallel optical plate 210 that is rotated in the incident beam 204 displaces the transmitted incident beam 204a parallel to the original beam direction. Similarly, the means for scanning can take the form of deflector mirror 310, acousto-optic crystal 410, or even lens 612 being deflected. Depending on the embodiment, the means for scanning might or might not include a lens in conjunction with some of the previously described structures. Some preferred embodiments of the means for scanning will permit beam dithering, but such is not necessary in all embodiments contemplated as within the scope of the invention.

With respect to the means for scanning of FIG. 2 (plane-parallel optical plate 210 that is rotated), the deflections are small, but consistent with beam dithering. As mentioned, an advantage of the plate scanner 200 is the automatic compensation of the beam motion by the beam returning through the plate 210. The rays will retrace their path to the beam-splitter 230, where the return signal beam 234 is directed to the quadrature detector 240. The high speed dither provides a well-defined detection frequency. Larger displacements of the beam to scan over the target may be accomplished by either translating the target, or by combining the plate dither with an additional displacement mechanism capable of large beam deflections, as described below.

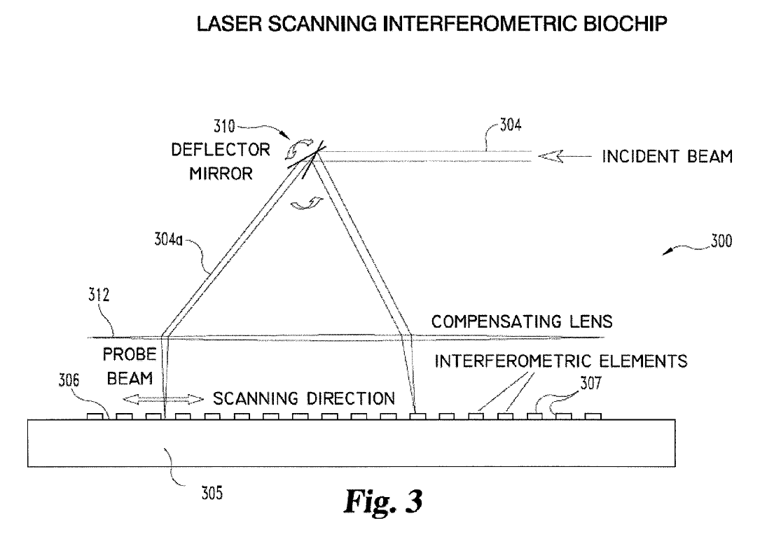

With reference to FIG. 3, there is shown a deflector mirror system 300 that redirects the incident beam 304 from the front focal point of a lens 312 into probe beam 304a toward surface 306 of target 305. Large displacements are possible in this configuration. High speed dither can be superposed on the slower larger displacements. That is to say, FIG. 3 shows an example wherein larger beam deflection is possible. This system 300 uses a conventional deflector mirror 310 as used in conventional laser scanner systems. The system 300 is telescopic, with the deflector 310 at the front focus of the compensator lens 312.

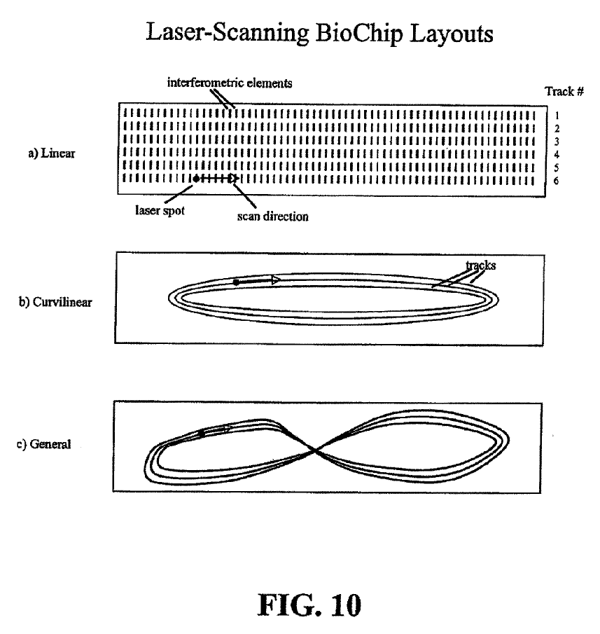

This system 300 has the advantage of larger displacements over the target substrate (examples of substrates including, but not limited to, chips such as biochips and electronic chips). On top of the large displacement, high-speed small-scale dither can be superposed in the drive circuit (not shown) of the deflector mirror 312. The deflector mirror 312 might, for example, be mounted on galvonometer drives, but can also be the facets of a rhomb that is spinning on a motor. The advantage of the rhomb is the high speed attainable with rotating systems that can rotate up to 6000 rpm. The large beam displacements in these systems can cover large areas of stationary chips in a short time. FIG. 3 depicts a linear laser scanning arrangement with interferometric elements arrayed along linear tracks on a planar substrate. The deflecting mirror scans the laser spot along the tracks. It should also be understood that while system 300 is shown as having a target 305 with a plurality of interferometric elements 307, the system 300 is more generally applicable for use in surface metrology that does not include interferometric elements 307, and that is not laid out along linear tracks. For example, generalized two dimensional scanning is contemplated as within the scope of the invention as is illustrated in FIGS. 10(a)-(c) and described below. It should also be understood that a wide variety of scanning configurations, linear or otherwise, are contemplated as within the scope of the invention.

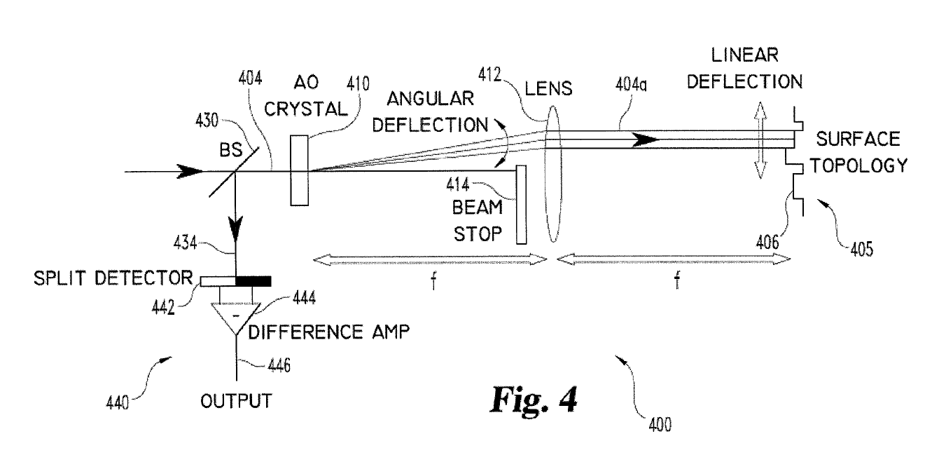

In another embodiment of the invention, the deflector unit 110 can be an acousto-optic modulator, as shown in FIG. 4. The acousto-optic crystal 410 supports a high-frequency sound wave that diffracts incident light 404 at an angle. The angle of diffraction is a function of the sound frequency, that can be adjusted. By sweeping the sound frequency in the crystal, the angular deflection is swept. The AO crystal 410 is preferably at the front focal point of the lens 412, and the beam 404a is focused onto the surface 406 of target 405. The system 400 preferably includes a beam stop 414 to block a portion of the incident beam 404 that might otherwise pass through the center of the lens. The return beam retraces the path to the AO modulator where it is diffracted back toward the source. The beam splitter 430 redirects the return light 434 for quadrature detection 440. In FIG. 4, quadrature detection 440 is in the form of a split detector 442 operating in phase-contrast quadrature that is preferably used in conjunction with differential amplifier 444 to produce output 446. In this system the dither is accomplished by superposing a high-speed frequency modulation on top of a slower scan frequency sweep.

The acousto-optic scanning system 400 shown in FIG. 4 preferably makes use of phase-contrast quadrature detection 440 [see U.S. utility application Ser. No. 11/345,462 being filed on the same day as the present application and entitled “Method and Apparatus for Phase Contrast Quadrature Interferometric Detection of an Immunoassay”, previously incorporated herein by reference]. There are preferably no moving parts giving this system 400 the capability of extremely high scan speeds and detection frequencies. That is to say, the absence of any moving parts makes this scanning capable of extremely high speeds in the MHz range, which is the frequency ranges where laser sources have lowest noise and can approach the shot-noise limit.

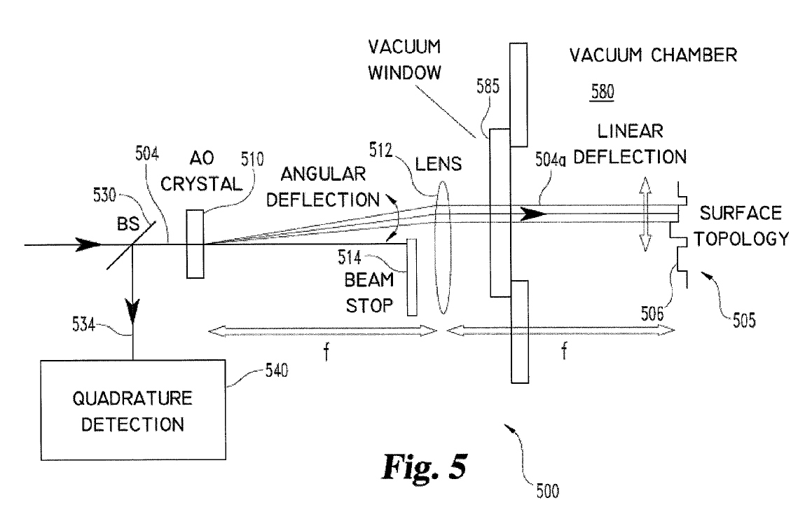

An example of one application of the scanning quadrature system will now be briefly discussed. With reference to FIG. 5 there is shown a scanner 500 that makes use of a probe beam that is transmitted through the high-vacuum window 585 of a vacuum chamber 580 to probe a surface 506 of a target 505 inside the chamber 580. The target 505 can be in a bioreactor, or in a materials processing system, such as a metal evaporator or a plasma etch system. Metal evaporation and plasma etching are extremely critical parts of semiconductor processing, and thickness monitoring of this process is critical. For instance, in Intel chips the thickness of the gate oxide must be monitored to nanometer accuracies during plasma etch.

The embodiment of FIG. 5 would be capable of this metrology application. With reference to FIG. 5, there is shown an example of an application in which the target 505 is inside a vacuum chamber 580. Optical access to the target is through the preferably substantially transparent vacuum window 585. This is an example of the utility of the scanning quadrature system in which the target either cannot move or is substantially stationary, yet all the advantages of high-speed quadrature detection can still be achieved.

With reference to FIG. 5, the generic deflector unit 110 is again preferably an acousto-optic modulator. The acousto-optic crystal 510 supports a high-frequency sound wave that diffracts incident probe light 504 at an angle. The angle of diffraction is a function of the sound frequency, that can be adjusted. By sweeping the sound frequency in the crystal, the angular deflection is swept. The AO crystal 510 is preferably at the front focal point of the lens 512, and the beam 504a is focused onto the surface 506 of target 505 through vacuum window 585. The system 500 preferably includes a beam stop 514 to block a portion of the incident beam 504 that might otherwise pass through the center of the lens. The return beam 534 retraces the path to the AO modulator where it is diffracted back toward the source. The beam splitter 530 redirects the return light 534 to quadrature detection 540. As in FIG. 4, quadrature detection 540 is preferably a split detector operating in phase-contrast quadrature.

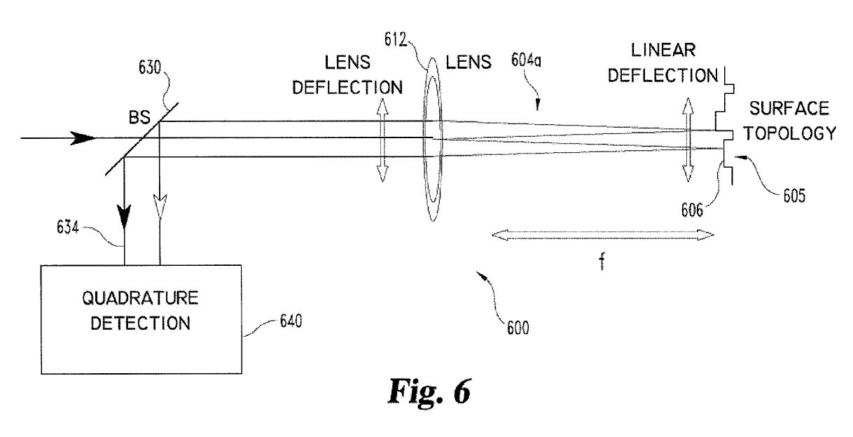

It should be understood that a wide variety of laser scanning interferometric surface metrology systems are contemplated as within the scope of the invention. For example, not all embodiments of the scanning system require all elements of FIG. 1. Referring to FIG. 6, there is shown a scanner 600. Scanner 600 is a more simple implementation that uses a lens 612 on a galvonometer mount. This type of lens system is used routinely in the read head of compact disc players. When the lens 612 is deflected, the focused beam 604a is deflected. The return beam 634 in this case does not exactly retrace the incident beam 604, thus causing beam “walk-off” on the quadrature detector 640. Nonetheless, by the use of only small-amplitude dither, this walk-off effect can be small enough to allow linear scanning and quadrature detection.

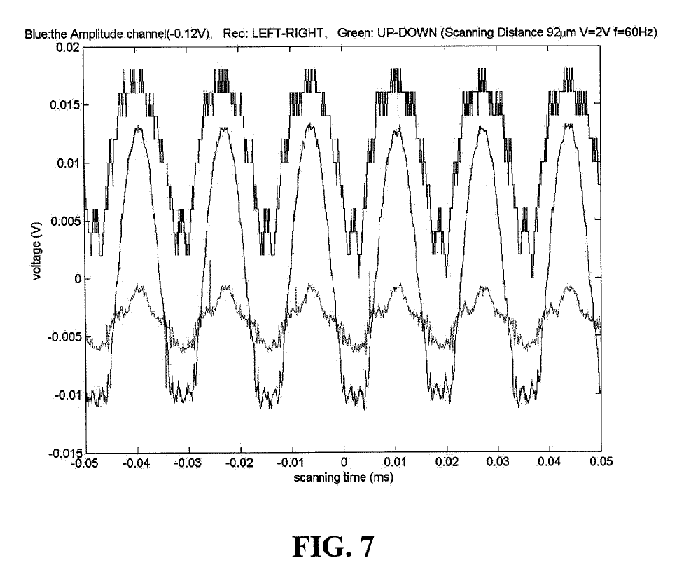

A time trace of the system of FIG. 6 is shown in FIG. 7, with a phase-contrast detection showing the amplitude channel and the two orthogonal phase channels. The amplitude channel is the upper trace. The left-right channel is the middle trace. The up-down channel is the lower trace. The walk-off effect causes the largest part of the signal modulation. However, by demodulating the slow walk-off effect, the high-frequency part contains the quadrature information. That is to say, the modulation is dominated by the walk-off, but the smaller structures show positive detection of a monolayer of antibody protein on a silicon wafer.

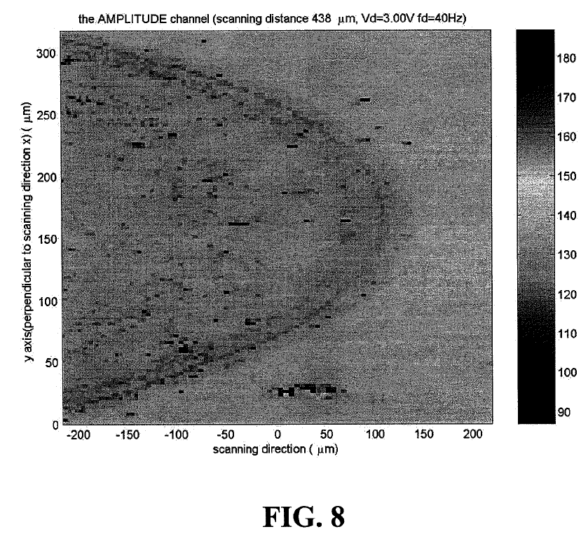

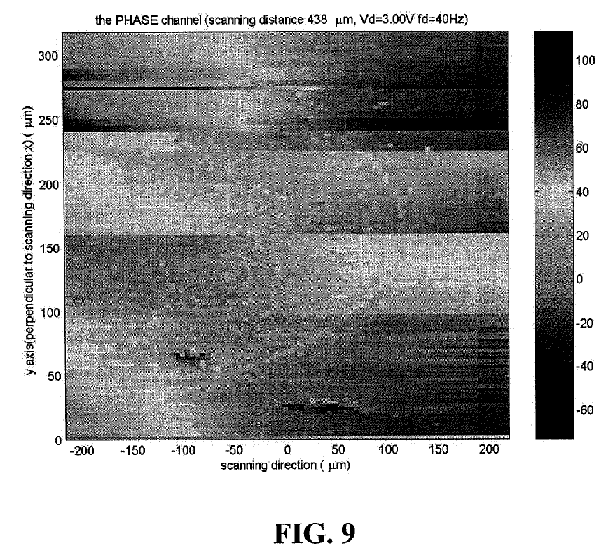

The use of this system to image protein printed on the surface of SiO₂/Si is shown in FIG. 8 and FIG. 9 for the amplitude and phase channels, respectively. With reference to FIG. 8 there is shown the amplitude channel after demodulating beam walk-off showing a monolayer of printed antibody protein on a silicon wafer. With reference to FIG. 9 there is shown the phase channel showing protein edge in the edge-detection mode of phase-contrast quadrature.

FIG. 10 illustrates possible scanning coordinates in two dimensions. It is understood that it is contemplated as within the scope of the invention that scanning can be accomplished in a wide variety of two-dimensional coordinate systems. Examples of this are illustrated in FIG. 10 where the trajectories are parametric trajectories in generalized curvilinear coordinates ξ(x,y), ξ(x,y). The trajectory is parameterized in time as ξ(t), ξ(t). The trajectories can be generalized arcs or segments that are open or closed, non-crossing or crossing.

In one exemplary embodiment of the present invention, a laser source, one or more steering mirrors, compensating optics, and interferometric elements arrayed along successive tracks in a two-dimensional plane are provided. The steering mirrors can move the probe laser spot in any number of trajectories across the biochip surface. As previously noted, a linear scanning arrangement is shown in FIG. 3. A linear scanning arrangement is also shown in FIG. 10a. In FIG. 10b, the trajectories are parametric trajectories in generalized curvilinear coordinates ξ(x,y), ξ(x,y). The trajectory is parameterized in time as ξ(t), ξ(t). In FIG. 10c, the trajectories are generalized arcs or segments that are open or closed, non-crossing or crossing. Thus, various applications of the present invention permit measurement of the molecular or cellular or particulate content of a liquid or gas sample in which an analyte binds to a substrate along lines, arcs or curves that are not localized in at least one spatial dimension of a generalized coordinate frame.

It should be understood that a wide variety of detector configurations are contemplated as within the scope of the invention for use as means for detecting a return signal in a substantially quadrature condition in, for example, embodiments of the present invention such the illustrated systems 100, 200, 300, 400, 500 and 600. For example, for MD-class systems the quadrature detection described in FIGS. 1-10 of U.S. application Ser. No. 10/726,772 filed Dec. 3, 2003 entitled “Adaptive Interferometric Multi-Analyte High-Speed Biosensor” (published as US 2004/0166593 on Aug. 26, 2004) might be used. This application was previously incorporated herein by reference. Similarly, the quadrature detection in the AO-class of detection disclosed in the remaining portion of U.S. application Ser. No. 10/726,772 (in particular see FIGS. 17-21) might be used. For example, such quadrature detection might make use of two photodetectors in conjunction with an adaptive element such as a photorefractive quantum well, photorefractive polymer, or general photorefractive material which exhibits the photorefractive effect. Furthermore, the means for detecting the return signal in a substantially quadrature condition might also be the structures disclosed for detection in U.S. utility application Ser. No. 11/345,462 being filed on the same day as the present application and entitled “Method and Apparatus for Phase Contrast Quadrature Interferometric Detection of an Immunoassay”, previously incorporated herein by reference. Those structures included various split photodetector configurations including, but not limited to, split-ring photodetector, quadrant photodetector, separate photodetectors or detector arrays (positioned in such a manner so as to detect the return signal in substantially one or both quadrature conditions). Such structures preferably were supplemented with an inversion circuit and summation circuit for inversion of the output of one substantially quadrature condition and summation of the inverted first output with the output for the second substantially quadrature condition.

It should also be understood that improvements in, for example, signal to noise ratio and other aspects of the invention(s) disclosed in U.S. utility application Ser. No. 11/345,566 being filed on the same day as the present application that claims priority to this provisional application and entitled “Differentially Encoded Biological Analyzer Planar Array Apparatus and Methods” (previously incorporated herein by reference) are contemplated for use with and as within the scope of the present invention.

While the present system is susceptible to various modifications and alternative forms, exemplary embodiments thereof have been shown by way of example in the drawings and will herein be described in detail. It should be understood, however, that there is no intent to limit the system to the particular forms disclosed, but on the contrary, the intention is to address all modifications, equivalents, and alternatives falling within the spirit and scope of the system as defined by the appended claims.

What is claimed is:

1. An apparatus for assessing topology of a surface of a target, comprising:
an optical source for generating a probe laser beam;
scanning optics for scanning the probe laser beam across at least a portion of the surface of the target, wherein the scanning optics moves the laser beam in different trajectories across the surface of the target;
means for detecting a return signal, the return signal resulting from reflection of the probe laser beam off the surface of the target; and
a beamsplitter positioned to redirect the return signal from the surface of the target toward the means for detecting the return signal in a substantially quadrature condition.

2. The apparatus of claim 1, wherein the scanning optics includes a parallel plate mirror.

3. The apparatus of claim 2, further comprising a galvanometer for rotating the parallel plate mirror at high speed.

4. The apparatus of claim 1, wherein the scanning optics includes a deflector mirror.

5. The apparatus of claim 4, further comprising a galvanometer for rotating the deflector mirror at high speed.

6. The apparatus of claim 1, wherein the scanning optics includes a lens that is laterally deflected.

7. The apparatus of claim 1, wherein the scanning optics includes an acousto-optic modulator.

8. The apparatus of claim 7, further comprising a lens with a focal length f for focusing the probe laser beam with a waist w₀ on the surface of the target, the lens being positioned between the scanning optics and the target.

9. The apparatus of claim 8, wherein the means for detecting the return signal in a substantially quadrature condition includes an adaptive optic element used in conjunction with two separate photodetectors.

10. The apparatus of claim 9, wherein the adaptive optic element is a photorefractive quantum well.

11. The apparatus of claim 8, wherein the means for detecting the return signal in a substantially quadrature condition includes a split photodetector.

12. The apparatus of claim 11, wherein the probe laser beam has a wavelength λ, and wherein the split photodetector is a detector array positioned at a pair of quadrature angles Θ_{q}, the quadrature angles being defined from a ray normal to the target by a formula: Θ_{q}=sin⁻¹(λ/2wₒ).

13. The apparatus of claim 11, further including an inverting circuit connected to the split photodetector and a summing circuit connected to both the split photodetector and to the inverting circuit.

14. The apparatus of claim 8, wherein the acousto-optic modulator is offset from the lens by a distance f, and wherein the lens is offset from the surface of the target by a distance f.

15. A quadrature interferometric method for determining the presence or absence of a target analyte in a sample, comprising:
generating a laser probe beam having a wavelength λ and a waist wₒ to probe at least a portion of a substrate having a reflecting surface that has been exposed to the sample, the reflecting surface including at least a first region having a layer of recognition molecules specific to the target analyte and a second region that does not include a layer of recognition molecules specific to the target analyte;
scanning the first region and the second region with crossing and non-crossing trajectories while the substrate is maintained in a substantially fixed position;
measuring a time dependent intensity of a reflected diffraction signal of the probe beam while scanning the probe beam across the first region and the second region.

16. The method of claim 15, wherein the scanning is done using an acousto-optic modulator in conjunction with a lens.

17. The method of claim 16, wherein the reflected diffraction signal of the laser beam is measured using a split-photodetector configuration, further comprising inverting a first output portion of the reflected signal corresponding to one of a pair of quadrature angles, and summing the inverted first output with a second output of the reflected signal corresponding to the other of the pair of quadrature angles.

18. The method of claim 17, wherein the reflecting surface is substantially flat and the quadrature angles are defined from a ray normal to the substrate by a formula: Θ_{q}=sin⁻¹(λ/2wₒ).

19. The method of claim 17, wherein the reflecting surface of the substrate includes a plurality of lands and a plurality of ridges, the ridges having a height h, and the quadrature angles are defined from a ray normal to the substrate by a formula:
Θ_{q}=sin⁻¹[(λ/2−4 h)/wₒ].

20. The method of claim 16, wherein scanning is sweeping an angular deflection by sweeping a sound frequency in the acousto-optic modulator, and further comprising dithering the probe laser beam, wherein the dithering is accomplished by superposing a high speed frequency on top of the slower scan frequency sweep.
